(19) United States
(12) Patent Application Publication
(10) Pub. No.: US 2022/0181923 A1
(43) Pub. Date: Jun. 9, 2022

(54) INTERCONNECTED ASSEMBLY, AND ROTATING ELECTRICAL MACHINE

(71) Applicants: SUMITOMO ELECTRIC INDUSTRIES, LTD., Osaka (JP); SUMITOMO ELECTRIC SINTERED ALLOY, LTD., Okayama (JP)

(72) Inventors: Tatsuya SAITO, Osaka (JP); Tomoyuki UENO, Osaka (JP); Yuichi NAKAMURA, Osaka (JP)

(21) Appl. No.: 17/594,398

(22) PCT Filed: Apr. 3, 2020
(86) PCT No.: PCT/JP2020/015419

§ 371 Date: Oct. 14, 2021

(30) Foreign Application Priority Data
May 9, 2019 (JP) 2019-089192

(51) Int. Cl. H02K 1/18; H02K 21/24

(52) U.S. Cl. CPC H02K 1/182; H02K 21/24

(57) ABSTRACT

An interconnected assembly includes a first member formed from a compressed mass of soft magnetic powder, a second member that is a separate piece from the first member, and a self-tapping screw extending through the second member to reach the first member to interconnect the first member and the second member, wherein at least the first member, among the first member and the second member, has a pilot hole into which a thread of the self-tapping screw bites, wherein an inner diameter of the pilot hole is greater than or equal to 83% and less than or equal to 95% of a major diameter of the self-tapping screw, and is greater than a minor diameter of the self-tapping screw, and wherein a helical gap is formed between an outer circumferential surface of the self-tapping screw and an inner circumferential surface of the pilot hole.

### TECHNICAL FIELD

The disclosures herein relate to an interconnected assembly and a rotating electrical machine.

The present application is based on and claims priority to Japanese patent application No. 2019-089192 filed on May 9, 2019, and the entire contents of the Japanese patent application are hereby incorporated by reference.

### BACKGROUND ART

As a rotating electrical machine such as an electric motor and an electric generator, Patent Document 1 discloses an axial-gap-type rotating electrical machine in which the rotor and the stator face each other in the direction of the rotation axis. The stator used in this rotating electrical machine includes an armature core having a back yoke and a plurality of teeth and coils arranged at the respective teeth.

The core disclosed in Patent Document 1 is an interconnected assembly made by interconnecting separately produced teeth and a yoke. More specifically, pillar-like projections of the teeth are fit into recesses in the yoke to produce the core. In Patent Document 1, the yoke is constructed of stacked steel plates, and the teeth are each constructed as a magnetic powder core that is a compressed powder mass.

### RELATED-ART DOCUMENTS

### Patent Document

[Patent Document 1] International Publication Pamphlet No. WO2007/114079

### SUMMARY OF THE INVENTION

An interconnected assembly according to the present disclosures includes:

a first member formed from a compressed mass of soft magnetic powder;

a second member that is a separate piece from the first member; and

a self-tapping screw extending through the second member to reach the first member to interconnect the first member and the second member,

wherein at least the first member, among the first member and the second member, has a pilot hole into which a thread of the self-tapping screw bites,

wherein an inner diameter of the pilot hole is greater than or equal to 83% and less than or equal to 95% of a major diameter of the self-tapping screw, and is greater than a minor diameter of the self-tapping screw, and

wherein a helical gap is formed between an outer circumferential surface of the self-tapping screw and an inner circumferential surface of the pilot hole.

A rotating electrical machine according to the present disclosures is

an axial-gap-type rotating electrical machine in which a rotor and a stator are arrayed in a direction of a rotation axis of the rotor, and which includes

the interconnected assembly of the present disclosures.

The interconnected assembly of the present disclosures is any one of the following:

(1) the interconnected assembly of the present disclosures in which the first member is a tooth used for a core of a rotating electrical machine, and the second member is a yoke used for the core; and
(2) the interconnected assembly of the present disclosures in which the first member is a tooth used for a core of a rotating electrical machine, and the second member is a flange section provided at an end of the tooth; and
(3) the interconnected assembly of the present disclosures in which the first member is a core used in a rotating electrical machine and including teeth and a yoke, and the second member is a housing for containing the core.

### BRIEF DESCRIPTION OF THE DRAWINGS

FIG. 1 is a partial vertical cross-sectional view of an axial-gap-type rotating electrical machine of a first embodiment.

FIG. 2 is a schematic axonometric view of a stator core provided in the axial-gap-type rotating electrical machine of the first embodiment.

FIG. 3 is a schematic axonometric view of a portion of the core shown in FIG. 2 as viewed from the side opposite from where teeth are located.

FIG. 4 is a partial cross-sectional view of the core shown in FIG. 2 taken along the direction of the axis of a self-tapping screw.

FIG. 5 is an enlarged partial view enlarging a portion of FIG. 4.

FIG. 6 is a drawing showing a photograph of a cross-section of the core of the first embodiment taken along the direction of the axis of a self-tapping screw.

FIG. 7 is a partial vertical cross-sectional view of an axial-gap-type rotating electrical machine of a second embodiment.

FIG. 8 is a partial vertical cross-sectional view of an axial-gap-type rotating electrical machine of a third embodiment.

FIG. 9 is a partial vertical cross-sectional view of an axial-gap-type rotating electrical machine of a fourth embodiment.

### MODE FOR CARRYING OUT THE INVENTION

### Problem to be Solved by the Present Disclosures

In the configuration disclosed in Patent Document 1, the teeth are press-fit into the recesses of the yoke, or the teeth are fixed in the recesses of the yoke with an adhesive. However, the securement of teeth by press-fit and the securement of teeth with an adhesive are cumbersome. An interconnected assembly interconnected by simpler configurations is thus required.

It is one of the objects of the present disclosures to provide an interconnected assembly that is interconnected by simple configurations and excels in productivity. Further, it is another one of the objects of the present disclosures to provide a rotating electrical machine that is provided with the interconnected assembly.

### Advantage of the Present Disclosures

The interconnected assembly according to the present disclosures excels in productivity. The rotating electrical machine according to the present disclosures excels in productivity.

### Description of Embodiments of the Present Disclosures

The inventors have studied how to secure compressed powder teeth to a yoke with screws. Since a compressed powder mass is brittle, screws are not usually used to secure a compressed powder mass to another member. This is because a crack or the like is created in a compressed powder mass when a screw hole is formed in the compressed powder mass and when a screw is fit into the screw hole. Upon conducting study, the inventors have found a configuration that can solve the above-noted problem. Specifically, the noted problem is solved by interconnecting a first member and a second member with a self-tapping screw and by optimizing the dimension of a pilot hole for receiving the self-tapping screw relative to the dimensions of the self-tapping screw.

Embodiments of the present disclosures will be listed and described in the following.

<1> An interconnected assembly according to an embodiment includes:

a first member formed from a compressed mass of soft magnetic powder;

a second member that is a separate piece from the first member; and

a self-tapping screw extending through the second member to reach the first member to interconnect the first member and the second member,

wherein at least the first member, among the first member and the second member, has a pilot hole into which a thread of the self-tapping screw bites,

wherein an inner diameter of the pilot hole is greater than or equal to 83% and less than or equal to 95 of a major diameter of the self-tapping screw, and is greater than a minor diameter of the self-tapping screw, and

wherein a helical gap is formed between an outer circumferential surface of the self-tapping screw and an inner circumferential surface of the pilot hole.

The interconnected assembly noted above is made by simply fixing the first member to the second member with the self-tapping screw. Securement by use of a self-tapping screw is easy, compared with securement by press-fit or by use of an adhesive. The interconnected assembly noted above thus excels in productivity.

In the interconnected assembly noted above, the inner diameter of the pilot hole to which the self-tapping screw is attached is greater than or equal to 83% of the major diameter of the self-tapping screw, and is greater than the minor diameter of the self-tapping screw. Use of the inner diameter of the pilot hole greater than or equal to 83% of the major diameter of the self-tapping screw reduces the likelihood that excessive stress is exerted to the pilot hole by the thread of the self-tapping screw. Use of the inner diameter of the pilot hole greater than the minor diameter of the self-tapping screw ensures that the pilot hole is not pressed outward and widened by the shank of the self-tapping screw. Accordingly, the interconnected assembly of the embodiment is unlikely to have a defect such as a crack. Further, use of the inner diameter of the pilot hole less than or equal to 95% of the major diameter of the self-tapping screw makes it unlikely for the self-tapping screw to become loose, thereby securely fixing the first member to the second member.

<2> One aspect of the interconnected assembly according to the embodiment may be configured such that

the second member is formed from a compressed mass of soft magnetic powder, and

the pilot hole extends from the first member through the second member.

In the above-noted configuration, each of the first member and the second member is a compressed mass of soft magnetic powder. In such a configuration also, optimally selecting the inner diameter of the pilot hole in response to the dimensions of the self-tapping screw makes it unlikely for a crack or the like to occur in the first member and the second member.

<3> One aspect of the interconnected assembly according to the embodiment may be configured such that

the proportion of an area of the gap in a total of a predetermined area in a cross-section taken along a plane including the axis of the self-tapping screw is greater than or equal to 45% and less than or equal to 65%,

the predetermined area being defined by

a first straight line connecting one crest of the thread and another crest of the thread adjacent thereto in the direction of the axis,

a second straight line including a root of the self-tapping screw and extending along the root,

a third straight line extending from the one crest of the thread in the direction perpendicular to the axis, and

a fourth straight line extending from said another crest of the thread in the direction perpendicular to the axis.

With the proportion of the area of the gap in a total of the predetermined area being greater than or equal to 45% and less than or equal to 65%, the amount of bite into the pilot hole by the self-tapping screw is arguably appropriate. Accordingly, an interconnected assembly for which the proportion of the area of the gap in a total of the predetermined area being greater than or equal to 45% and less than or equal to 65% is arguably the one which provides strong securement through the self-tapping screw between the first member and the second member. The interconnected assembly is also arguably the one which is unlikely to develop a crack or the like in a compressed powder mass.

<4> One aspect of the interconnected assembly according to the embodiment may be configured such that

the self-tapping screw is of a B-0 type or a B-1 type.

The self-tapping screw of the B-0 type is mainly used for fixing a resin material. The self-tapping screw of the B-1 type is the one which is used for fixing a resin material, and is also the one which has a groove formed in the tip thereof serving as a cutting blade. These self-tapping screws are suitable for securement of a compressed powder mass.

<5> One aspect of the interconnected assembly according to the embodiment may be configured such that

a thread angle at a distal section of the self-tapping screw is smaller than a thread angle of a proximal section thereof.

The thread angle refers to an angle formed by the two flanks having a crest of the thread therebetween in a cross-section extending in the axial direction of the self-tapping screw. Namely, a small thread angle means that the thread has a thin thickness and that the thread is sharp. Such a self-tapping screw is easily screwed into a pilot hole.

<6> One aspect of the interconnected assembly according to the embodiment may be configured such that

the self-tapping screw is a nonmagnetic material.

In the case in which the interconnected assembly is used as a core of a rotating electrical machine, use of a nonmagnetic-material self-tapping screw reduces core loss caused by the self-tapping screw.

<7> One aspect of the interconnected assembly according to the embodiment may be configured such that

the nonmagnetic material is resin, a titanium alloy, brass, an aluminum alloy, a magnesium alloy, or nonmagnetic stainless steel.

The materials noted above have strength required of a self-tapping screw.

<8> One aspect of the interconnected assembly according to the embodiment may be configured such that

the self-tapping screw is a magnetic material.

In the case in which the interconnected assembly is used as a core of a rotating electrical machine, use of a magnetic-material self-tapping screw reduces a decrease in the torque of the rotating electrical machine caused by the self-tapping screw.

<9> One aspect of the interconnected assembly according to the embodiment may be configured such that

the magnetic material is steel or magnetic stainless steel.

The materials noted above have strength required of a self-tapping screw.

<10> One aspect of the interconnected assembly according to the embodiment may be configured such that

five or more ridges of the thread bite into the pilot hole of the first member.

In the present specification, one ridge of the thread refers to a portion of the thread for one pitch. Five or more ridges of the thread biting into the pilot hole provide strong securement between the first member and the second member.

<11> One aspect of the interconnected assembly according to the embodiment may be configured such that

the distance between the bottom of the pilot hole and the tip of the self-tapping screw is greater than or equal to 0.5 mm and less than or equal to 5 mm.

Provision of the distance greater than or equal to 0.5 mm ensures that the tip of the self-tapping screw does not press the bottom of the pilot hole. Damage to the first member caused by the tip of the self-tapping screw is thus reduced. Provision of the distance less than or equal to 5 mm ensures that a sufficient bulk of the first member is secured. Degradation in the magnetic property of the first member is thus reduced.

<12> One aspect of the interconnected assembly according to the embodiment may be configured such that

the inner circumferential surface of the pilot hole has a tapered shape with an angle of 1 degree or more and 10 degrees or less relative to the axis of the pilot hole.

The pilot hole having a predetermined tapered shape can be formed by molding. For example, a mold with a core for forming a pilot hole may be used to make a compressed powder mass. In this case, providing the pilot hole with a tapered shape allows the core to be easily disengaged from the compressed powder mass. Creating a pilot hole in a compressed powder mass by molding makes it unnecessary to apply a machining process to the compressed powder mass. A crack or the like thus is unlikely to occur in a compressed powder mass.

<13> One aspect of the interconnected assembly according to the embodiment may be configured such that

in a cross-section taken along a plane including the axis of the self-tapping screw, the thickness of the first member and the thickness of the second member extending from the inner circumferential surface of the pilot hole in the direction perpendicular to the axis are greater than or equal to 2 mm.

With the noted configuration, sufficient thicknesses of the first member and the second member around the pilot hole in the radial direction are secured. As a result, when the first member and the second member are fixed with the self-tapping screw, a crack or the like is unlikely to occur in the first member and the second member.

<14> One aspect of the interconnected assembly according to the embodiment may be configured to further include

a filler material disposed in the helical gap.

The filler material is preferably injected into the pilot hole before securement by the self-tapping screw. Injecting the filler material into the pilot hole makes it unlikely for a crack or the like to occur in the compressed powder mass when the self-tapping screw is fit into the pilot hole. This is because friction between the self-tapping screw and the pilot hole decreases. Further, filling the gap between the inner circumferential surface of the pilot hole and the outer circumferential surface of the self-tapping screw with the filler material improves the strength of the compressed powder mass.

<15> One aspect of the interconnected assembly according to the embodiment may be configured such that

the head of the self-tapping screw is a countersunk head, a truss head, or a binding head.

The self-tapping screws having the heads noted above are suited to interconnect the first member and the self-tapping screw.

<16> One aspect of the interconnected assembly according to the embodiment may be configured such that

a relative density of the first member is greater than or equal to 90%,

wherein the second member is a compressed mass of soft magnetic powder, and a relative density of the second member is greater than or equal to 90%.

The relative densities of the first member and the second member can be obtained by image analysis or the like as will be shown in the embodiments described later.

A compressed powder mass with the relative density greater than or equal to 90% excels in magnetic property. Further, a compressed powder mass with the relative density greater than or equal to 90% excels in strength. Accordingly, when the first member and the second member are fixed with a self-tapping screw, cracking, chipping, or the like are unlikely to occur in the compressed powder mass.

<17> One aspect of the interconnected assembly according to the embodiment may be configured such that

the first member is a tooth used for a core of a rotating electrical machine, and

the second member is a yoke used for the core.

With the above arrangement, the tooth is easily fixed to the yoke.

<18> One aspect of the interconnected assembly according to the embodiment may be configured such that

the first member is a tooth used for a core of a rotating electrical machine, and

the second member is a flange section provided at an end of the tooth.

With the above arrangement, the flange section is easily fixed to the tooth.

<19> One aspect of the interconnected assembly according to the embodiment may be configured such that

the first member is a core used in a rotating electrical machine and including teeth and a yoke, and

the second member is a housing for containing the core.

With the above arrangement, the core is easily fixed to the housing.

<20> A rotating electrical machine according to the embodiment is

an axial-gap-type rotating electrical machine in which a rotor and a stator are arrayed in the direction of a rotation axis of the rotor,

comprising the interconnected assembly recited in any one of <17> to <19>.

The rotating electrical machine noted above excels in productivity. This is because one or more of the parts constituting the rotating electrical machine is the interconnected assembly of the present disclosures that excels in productivity.

### Details of Embodiments of the Present Disclosures

A description will be given of an interconnected assembly of the embodiment of the present disclosures and of a specific example of a rotating electrical machine using the interconnected assembly, with reference to the drawings. In the drawings, the same reference characters represent the same or corresponding elements. The present invention is not limited to those examples, and are intended to include any variations and modifications which may be made without departing from the scope of the claims and from the scope warranted for equivalents of the claimed scope.

### First Embodiment

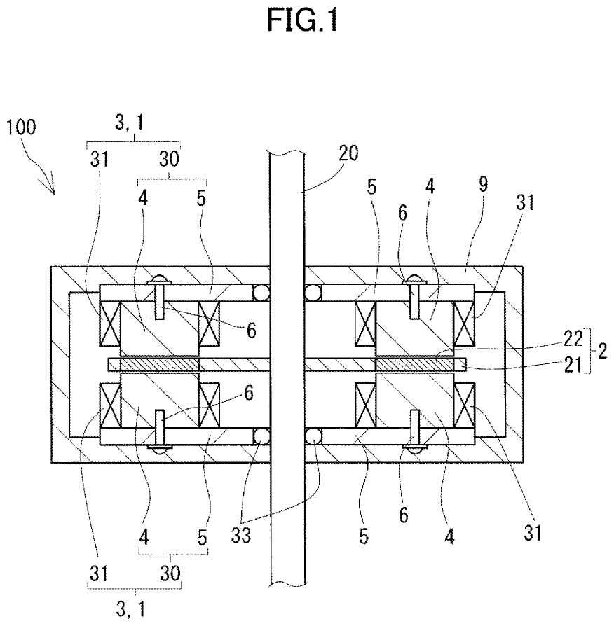

In the first embodiment, a description will be given with respect to a core 30 that is an interconnected assembly 1 of the present disclosures and that is provided in a rotating electrical machine 100 illustrated in FIG. 1.

### <<Rotating Electrical Machine>>

The rotating electrical machine 100 may be an electric generator, or an electric motor such as a motor. The rotating electrical machine 100 includes a rotor 2 and a stator 3 disposed in a housing 9. The rotating electrical machine 100 of this example is an axial-gap-type rotating electrical machine 100 in which the rotor 2 and the stator 3 are arrayed in the direction of the rotation axis of the rotor 2.

Rotor

The rotor 2 includes a plurality of flat plate magnets 22 and an annular support plate 21 for supporting the magnets 22. The support plate 21 is fixed to a shaft 20, and rotates together with the shaft 20. The magnets 22 are embedded in the support plate 21. The magnets 22 are arranged at spaced intervals in the circumferential direction of the shaft 20. The magnets 22 are magnetized in the direction of the rotation axis of the rotor 2, i.e., in the axis direction of the shaft 20. The magnets 22 adjacent to each other in the circumferential direction of the shaft 20 have magnetized directions opposite to each other.

Stator

The stator 3 includes the core 30 and coils 31 disposed around teeth 4 of the core 30. The rotating electrical machine 100 of the present example includes two stators 3. The end faces of the teeth 4 of one stator 3 oppose the end faces of the teeth 4 of the other stator 3. The stators 3 and 3 face the rotor 2 in the axis direction of the shaft 20, and are fixed to the housing 9. Namely, the rotor 2 is interposed between the two stators 3 and 3. A bearing 33 is disposed between the stator 3 and the shaft 20, and the stator 3 does not rotate. The core 30 provided in the stator 3 is an interconnected assembly 1 of the present disclosures.

### <<Core>>

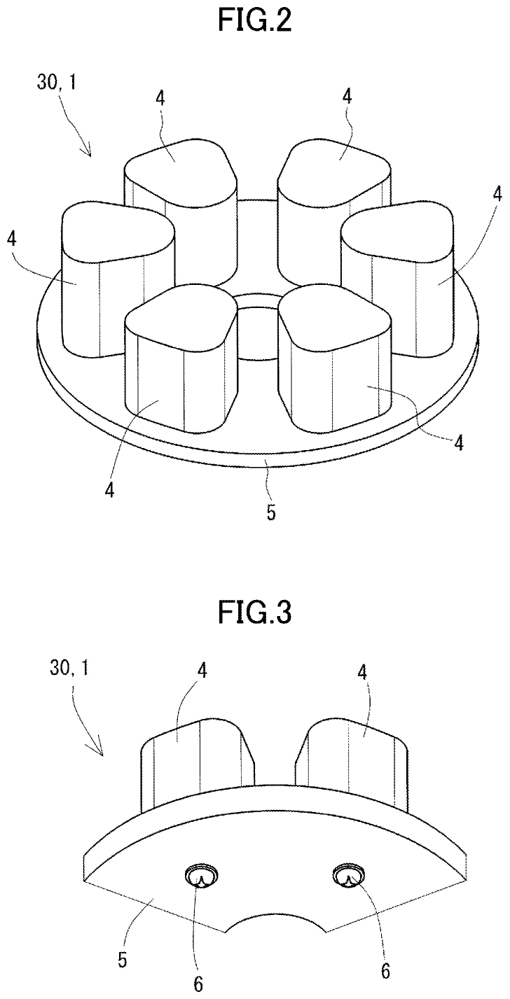

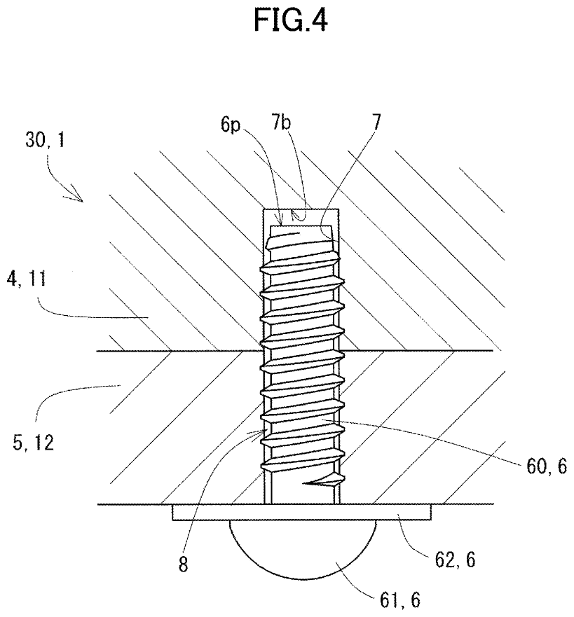

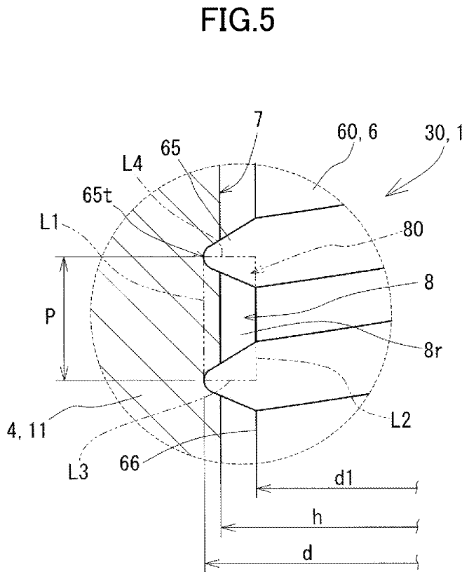

As illustrated in FIG. 1 through FIG. 3, the core 30 which is the interconnected assembly 1 in this example includes the teeth 4 and a yoke 5. The core 30 in this example includes 6 teeth 4 (FIG. 2). The number of teeth 4 is not limited to a particular number. In the case in which the rotating electrical machine 100 is used with three-phase alternating currents, the number of teeth 4 is set to 3n. n is a natural number. In this example, the teeth 4 are first members 11 (FIG. 4), and the yoke 5 is a second member 12 (FIG. 4). The teeth 4 and the yoke 5 are separately made.

Teeth

The teeth 4 of the present example are each a member having approximately a right trapezoidal prism shape. The shape of teeth 4 is not limited to a particular shape. For example, the teeth 4 may have approximately a right triangular prism shape. Other examples of the shape of the teeth 4 include a right circular cylinder, a right rectangular prism, and the like. A flange section may be provided at the end of the teeth 4 on the opposite side thereof from the yoke 5. The flange section is a member extending in the directions perpendicular to the direction in which the teeth 4 protrude, and is provided as an integral part of the teeth 4.

The teeth 4 are a compressed powder mass made by compressing soft magnetic powder in a mold. The soft magnetic powder is a collection of soft magnetic particles. Examples of the soft magnetic powder include pure iron having a purity of 99 mass % or more, and at least one powder selected from iron-based alloys such as an Fe—Si—Al-based alloy, an Fe—Si-based alloy, an Fe—Al-based alloy, and an Fe—Ni-based alloy. Fe is iron. Si is silicon. Al is aluminum. Ni is nickel. An Fe—Si—Al-based alloy may be sendust. An Fe—Si-based alloy may be silicon steel. An Fe—Ni-based alloy may be permalloy. The soft magnetic particles preferably have an insulating coating on the surface thereof. Provision of an insulating coating on the surface of soft magnetic particles ensures electrical insulation between the soft magnetic particles. With this arrangement, iron loss caused by eddy current loss is reduced in the teeth 4. Examples of the insulating coating include a phosphate coating and a silica coating.

The average diameter of soft magnetic particles is preferably greater than or equal to 10 μm and less than or equal to 300 μm. Use of the average diameter of soft magnetic particles greater than or equal to 10 μm reduces an increase in the coercive force and hysteresis loss of a compressed powder mass. Use of the average diameter of soft magnetic particles less than or equal to 300 μm reduces the eddy current loss of a compressed powder mass generated in the radio-frequency range. A more preferable average diameter of soft magnetic particles is greater than or equal to 40 μm and less than or equal to 260 μm. Here, the average diameter refers to the particle diameter at which the sum of mass of particles having particle diameters smaller than this diameter in a particle diameter histogram reaches 50% of the total mass, i.e., 50% particle diameter.

The relative density of the compressed powder mass is preferably greater than or equal to 90%. As the density of the compressed powder mass increases, the magnetic property of the compressed powder mass improves. The relative density of the compressed powder mass is preferably greater than or equal to 93%, more preferably greater than or equal to 94%, and further more preferably greater than or equal to 95%. The relative density noted above is a value obtained by dividing the actual density of a compressed powder mass by the true density. The actual density can be obtained by measuring the cubic volume of a compressed powder mass by using the Archimedes method and then dividing the mass of the compressed powder mass by the measured cubic volume. The true density can be obtained by using a measuring device such as a pycnometer.

Yoke

The yoke 5 is an annular member. The yoke 5 of the present example is constructed as a single member. The yoke 5 may alternatively be made by combining a plurality of separate pieces. For example, fan-shaped separate pieces may be interconnected to form the annular yoke 5.

Like the teeth 4, the yoke 5 is made of a compressed powder mass. The composition of the compressed powder mass forming the yoke 5 may be the same as, or may be different from, the composition of the compressed powder mass forming the teeth 4. Also, the relative density of the yoke 5 may be the same as, or may be different from, the relative density of the teeth 4. It should be noted that the relative density of the yoke 5 is preferably greater than or equal to 90%.

Interconnected Structure of Teeth and Yoke

The teeth 4 and the yoke 5 constituting the core 30 are fixed to each other with self-tapping screws 6. The self-tapping screws 6 are fit into the teeth 4 from the surface of the yoke 5 on the opposite side thereof from the teeth 4. The core 30, the teeth 4, and the yoke 5 are the interconnected assembly 1, the first members 11, and the second member 12, respectively.

As illustrated in FIGS. 4 and 5, the interconnected assembly 1 in this example has a pilot hole 7 extending through the second member 12 into the first member 11. Namely, the pilot hole 7 extends from the first member 11 through the second member 12. The pilot hole 7 includes a through hole extending through the second member 12 and a blind hole extending into the first member 11. The through hole and the blind hole are coaxial. The inner diameter of the through hole is the same as the inner diameter of the blind hole, or is greater than the inner diameter of the blind hole. The pilot hole 7 is preformed in the first member 11 and the second member 12. The thread 65 of the self-tapping screw 6 bites into the inner circumferential surface of the pilot hole 7 (FIG. 5).

It is preferable for five or more ridges of the thread 65 to bite into the pilot hole 7. Specifically, five or more ridges of the thread 65 preferably bite into the portion of the pilot hole 7 corresponding to the first member 11. Five or more ridges of the thread 65 biting into the pilot hole 7 provide strong securement between the first member 11 and the second member 12.

As illustrated in FIG. 5, the inner diameter h of the pilot hole 7 is greater than or equal to 83 and less than or equal to 95 of the major diameter d of the self-tapping screw 6, and is greater than the minor diameter d1 of the self-tapping screw 6. The major diameter d is the diameter of the self-tapping screw 6 at the position corresponding to the crest 65t of the thread 65. The minor diameter d1 is the diameter at the position corresponding to the root that is the bottom of a valley 66. Use of the inner diameter h of the pilot hole 7 greater than or equal to 83t of the major diameter d of the self-tapping screw 6 reduces the likelihood that excessive stress is exerted to the pilot hole 7 by the thread 65 of the self-tapping screw 6. Use of the inner diameter h of the pilot hole 7 less than or equal to 95% of the major diameter d of the self-tapping screw 6 ensures that the thread 65 sufficiently bites into the pilot hole 7. Use of the inner diameter h of the pilot hole 7 greater than the minor diameter d1 of the self-tapping screw 6 ensures that the pilot hole 7 is not pressed outward and widened by the shank 60 of the self-tapping screw 6. As a result, the first members 11 and the second member 12 formed from compressed powder masses are unlikely to develop a defect such as a crack.

A preferable value of the inner diameter h of the pilot hole 7 is greater than or equal to 84% and less than or equal to 94% of the major diameter d of the self-tapping screw 6. A more preferable value of the inner diameter h of the pilot hole 7 is greater than or equal to 85% and less than or equal to 93% of the major diameter d of the self-tapping screw 6.

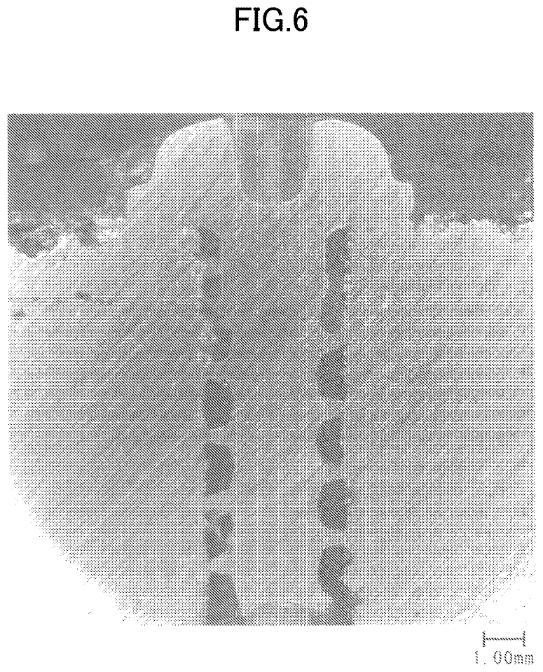

The valley 66 of the self-tapping screw 6 is not in contact with the pilot hole 7 (see a photograph of a real article shown in FIG. 6). As a result, a helical gap 8 is formed between the outer circumferential surface of the self-tapping screw 6 and the inner circumferential surface of the pilot hole 7 in the interconnected assembly 1 in this example. Specifically, the outer circumferential surface of the self-tapping screw 6 is comprised of the outer circumferential surface of the thread 65 and the outer circumferential surface of the valley 66.

The proportion of an area of the gap 8 in a total of a predetermined area 80 in a cross-section taken along a plane including the axis of the self-tapping screw 6 shown in FIG. 5 is preferably greater than or equal to 45% and less than or equal to 65%, The predetermined area 80 is surrounded by a first straight line L1, a second straight line L2, a third straight line L3, and a fourth straight line L4 in the noted cross-section. The first straight line L1 is a straight line connecting one crest 65t of the thread 65 and another crest 65t of the thread 65 adjacent thereto in the direction of the axis, The second straight line L2 is a straight line including the root that is the bottom the valley 66 of the self-tapping screw 6 and extending along the root, The third straight line L3 is a straight line extending from the one crest 65t of the thread 65 in the direction perpendicular to the axis. The fourth straight line L4 is a straight line extending from said another crest 65t of the thread 65 in the direction perpendicular to the axis.

With the proportion of the area of the gap 8 in a total of the predetermined area 80 being greater than or equal to 45% and being 65%, the amount of bite into the pilot hole 7 by the self-tapping screw 6 is arguably appropriate. Accordingly, the interconnected assembly 1 for which the proportion of the area of the gap 8 in a total of the predetermined area 80 being greater than or equal to 45% and being 65% is arguably the interconnected assembly 1 that provides strong securement through the self-tapping screw 6 between the first member 11 and the second member 12. Further, the interconnected assembly 1 is arguably such that the first members 11 and the second member 12 formed from compressed powder masses are unlikely to develop a crack or the like. A more preferable area proportion is greater than or equal to 47% and less than or equal to 63%. A further more preferable area proportion is greater than or equal to 49% and less than or equal to 61%.

As illustrated in FIG. 4, a gap is preferably formed between the bottom 7b of the pilot hole 7 and the tip 6p of the self-tapping screw 6. The distance between the bottom 7b of the pilot hole 7 and the tip 6p of the self-tapping screw 6 is preferably greater than or equal to 0.5 mm and less than or equal to 5 mm. Provision of the noted distance greater than or equal to 0.5 mm ensures that the tip 6p of the self-tapping screw 6 does not press the bottom 7b of the pilot hole 7. Damage to the first member 11 caused by the tip of the self-tapping screw 6 is thus reduced. Further, provision of the noted distance less than or equal to 5 mm ensures that a sufficient bulk of the first member 11 is secured. Degradation in the magnetic property of the first member 11 is thus reduced. The distance is more preferably greater than or equal to 1 mm and less than or equal to 4 mm.

The self-tapping screw 6 in the present example is a B-0-type self-tapping screw 6. The B-0-type self-tapping screw 6 is mainly used for fixing a resin material. Further, in order to make it easier for the self-tapping screw 6 to be screwed into the pilot hole 7, a thread angle at the distal section of the self-tapping screw 6 may be made smaller than a thread angle of the proximal section thereof.

The self-tapping screw 6 includes the shank 60 having the thread 65 and a head 61 provided at an end of the shank 60. The head 61 in this example is a pan head, but is not limited to a particular head. For example, the head 61 may be a countersunk head, a truss head, or a binding head. The self-tapping screw 6 in this example further includes a washer 62 formed as an integrated part of the head 61. The washer 62 does not have to be provided.

The pitch P of the self-tapping screw 6 is preferably greater than or equal to 25% and less than or equal to 43% of the major diameter. The pitch P is the distance between two threads 65 adjacent to each other in the axis direction. Use of the pitch P greater than or equal to 25% of the major diameter makes it unlikely for excessive stress to be applied to the pilot hole 7. Use of the pitch P less than or equal to 43% of the major diameter causes the thread 65 of the self-tapping screw 6 to reliably bite into the pilot hole 7. Accordingly, securement by the self-tapping screw 6 between the first member 11 and the second member 12 is strengthened. A more preferable pitch P is greater than or equal to 28% and less than or equal to 40% of the major diameter.

The self-tapping screw 6 may be a nonmagnetic material, or may be a magnetic material. Examples of the nonmagnetic material include resin, a titanium alloy, brass, an aluminum alloy, a magnesium alloy, nonmagnetic stainless steel, and the like. Examples of the resin include nylon (registered trademark), polycarbonate, PEEK (polyetheretherketone), and the like. These nonmagnetic materials excel in strength, and are thus suitable as a material for the self-tapping screw 6. Use of the nonmagnetic-material self-tapping screw 6 reduces the occurrence of eddy current in the self-tapping screw 6. As a result, core loss that is energy loss in the core 30 is reduced. In particular, stainless steel excels in corrosion resistance, and can thus reduce the likelihood that the self-tapping screw 6 loosens as a result of corrosion.

Examples of the magnetic material forming the self-tapping screw 6 include steel, ferromagnetic stainless steel, and the like These ferromagnetic materials excel in strength, and are thus suitable as a material for the self-tapping screw 6. Use of the magnetic-material self-tapping screw 6 allows the self-tapping screw 6 to function as part of the core 30. A decrease in the torque of the rotating electrical machine 100 (FIG. 1) caused by using the self-tapping screw 6 is thus reduced. In particular, stainless steel excels in corrosion resistance, and can thus reduce the likelihood that the self-tapping screw 6 loosens as a result of corrosion.

The inner circumferential surface of the pilot hole 7 formed in the first member 11 and the second member 12 preferably has a tapered shape with an angle of 1 degree or more and 10 degrees or less relative to the axis thereof. In the case in which the pilot hole 7 has a tapered shape, the inner diameter h of the pilot hole 7 needs to satisfy the requirements set forth in the present disclosures at the position where the inner diameter h of the pilot hole 7 is the smallest among the positions at which the thread 65 of the self-tapping screw 6 is in contact with the pilot hole 7. The pilot hole 7 having a predetermined tapered shape can be formed by molding. For example, a mold with a core for forming the pilot hole 7 may be used to make the first member 11 and the second member 12. In this case, providing the pilot hole 7 with a tapered shape allows the core to be easily disengaged from the first member 11 and the second member 12. Creating the pilot hole 7 in the first member 11 and the second member 12 by molding makes it unnecessary to apply a machining process to the first member 11 and the second member 12. As a result, the first member 11 and the second member 12 are unlikely to develop a crack or the like.

In a cross-section taken along a plane including the axis of the self-tapping screw 6 shown in FIG. 4, the thickness of the first member 11 and the thickness of the second member 12 extending from the inner circumferential surface of the pilot hole 7 in a direction perpendicular to the axis are preferably greater than or equal to 2 mm. The direction perpendicular to the axis is a left-and-right direction on the drawing sheet of FIG. 4. With the noted configuration, sufficient thicknesses of the first member 11 and the second member 12 around the pilot hole 7 in the radial direction are secured. As a result, when the first member 11 and the second member 12 are fixed with the self-tapping screw 6, a crack or the like is unlikely to occur in the first member 11 and the second member 12.

As is illustrated in FIG. 5, a filler material 8r may be disposed in the gap 8. The filler material 8r is preferably injected into the pilot hole 7 before securement by the self-tapping screw 6. Injecting the filler material 8r into the pilot hole 7 makes it unlikely for a crack or the like to occur in the first member 11 and the second member 12 when the self-tapping screw 6 is fit into the pilot hole 7. This is because friction between the self-tapping screw 6 and the pilot hole 7 decreases. Further, injecting the filler material 8r into the gap 8 increases the strength of the first member 11 and the second member 12. Examples of the filler material 8r include an epoxy-based adhesive and the like.

### Advantages of Present Embodiment

In the embodiment described above, the core 30 is the interconnected assembly 1, with the teeth 4 being the first members 11, and the yoke 5 being the second member 12. The core 30 of the noted embodiment is made by simply fixing the teeth 4 and the yoke 5 together with the self-tapping screws 6. Securement by use of the self-tapping screws 6 is easy, compared with securement by press-fit or by use of an adhesive. The core 30 of the first embodiment thus excels in productivity.

The stator 3 (FIG. 1) provided with the core 30 of the embodiment excels in productivity. This is because the productivity of the core 30 provided in the stator 3 is high.

The rotating electrical machine 100 provided with the stator 3 of the embodiment excels in productivity. This is because the productivity of the stator 3 provided in the rotating electrical machine 100 is high.

### Second Embodiment

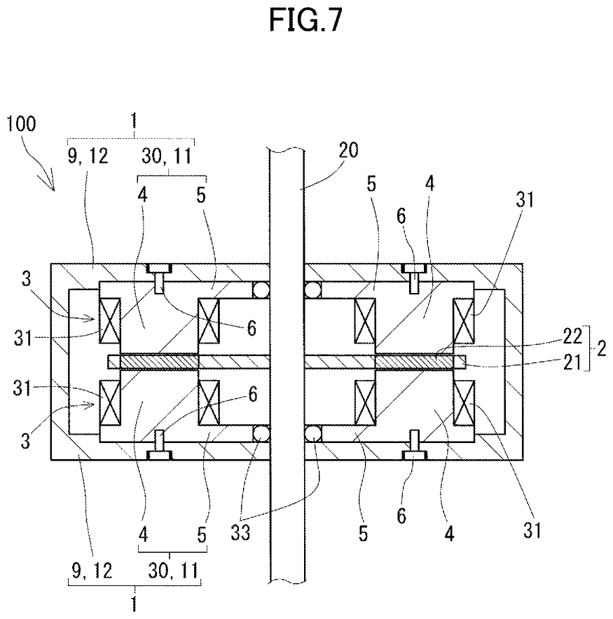

In the second embodiment, a description will be given based on FIG. 7 with respect to the rotating electrical machine 100 in which the core 30 is fixed to the housing 9 by the self-tapping screws 6.

The core 30 of the second embodiment is a compressed powder mass that is one unitary piece including the teeth 4 and the yoke 5. Namely, the core 30 is the first member 11 in this example. The core 30 is fixed to the housing 9 with the self-tapping screws 6. Namely, the housing 9 is the second member 12 in this example. The material of the housing 9 may be a nonmagnetic material such as an aluminum alloy.

In the case in which the inner diameter of the pilot hole 7 is substantially the same as in the first embodiment, the core 30 is fixed to the housing 9 without generating a crack or a fracture in the compressed powder mass forming the core 30. The configuration of this example makes it easy to produce the rotating electrical machine 100. This is because a worker simply threadably fixes the core 30 to the housing 9 to ensure that core 30 is secured to the housing 9.

### Third Embodiment

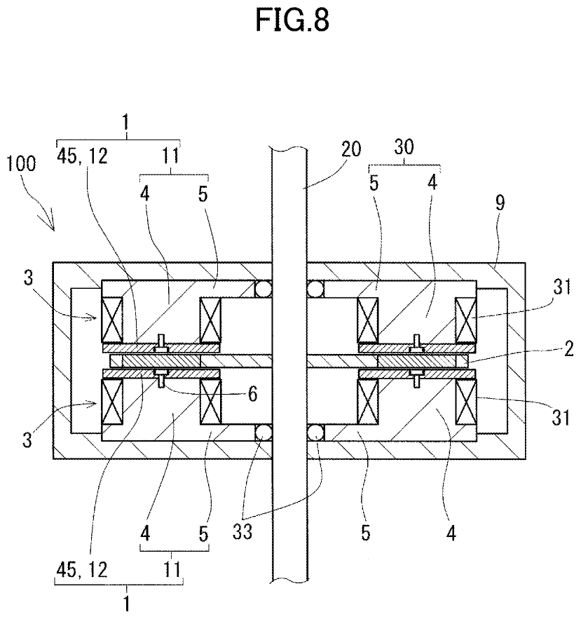

In the third embodiment, a description will be given based on FIG. 8 with respect to the rotating electrical machine 100 in which flange sections 45 are provided at ends of the teeth 4.

A flange section 45 that extends in directions perpendicular to the direction in which the teeth 4 protrude is provided at the end of each of the teeth 4 on the opposite side thereof from the yoke 5. The flange sections 45 make it difficult for the coils 31 disposed around teeth 4 to disengage from the teeth 4. Further, the flange sections 45 improve the performance of the axial-gap-type rotating electrical machine 100.

In this example, a unitary piece comprised of the teeth 4 and the yoke 5 is the compressed powder mass forming the first member 11. The flange sections 45 are the second members 12 that are separate pieces from the teeth 4. The flange sections 45 may be a compressed powder mass, or may be a composite steel plate.

In the case in which the inner diameter of the pilot hole 7 is substantially the same as in the first embodiment, neither a crack nor a fracture is developed in the flange sections 45 even when the flange sections 45 are a compressed powder mass. The configuration of this example makes it easy to form the flange sections 45. This is because a worker simply threadably fixes the flange sections 45 to the ends of the teeth 4 to ensure that the flange sections 45 are secured to the teeth 4. As a result, the productivity of the rotating electrical machine 100 improves. With the configuration of this example, further, the gap between the teeth 4 and the flange sections 45 can be made small, compared with the conventional configuration providing securement through an adhesive, so that degradation in the performance of a motor can be reduced.

### <<Variation 3-1>>

A variation of the third embodiment may be such that the configuration of the first embodiment is applied to the configuration of the third embodiment. Namely, the configuration may be such that the teeth 4, the yoke 5, and the flange sections 45 are separately made, followed by threadably fixing the teeth 4 and the yoke 5 together, and then threadably fixing the teeth 4 and the flange sections 45 together. When interconnecting the teeth 4 and the yoke 5 to each other, the teeth 4 are the first members 11, and the yoke 5 is the second member 12. Further, when interconnecting the teeth 4 and the flange sections 45 to each other, the teeth 4 are the first members 11, and the flange sections 45 are the second members 12.

### <<Variation 3-2>>

A variation of the third embodiment may be such that the configuration of the second embodiment is applied to the configuration of the third embodiment. Namely, the teeth 4 and the flange sections 45 of the core 30 are threadably fixed to each other, and the core 30 is threadably fixed to the housing 9. When interconnecting the teeth 4 and the flange sections 45 to each other, the core 30 is the first member 11, and the flange sections 45 are the second members 12. Further, when interconnecting the core 30 and the housing 9 to each other, the core 30 is the first member 11, and the housing 9 is the second member 12.

### Fourth Embodiment

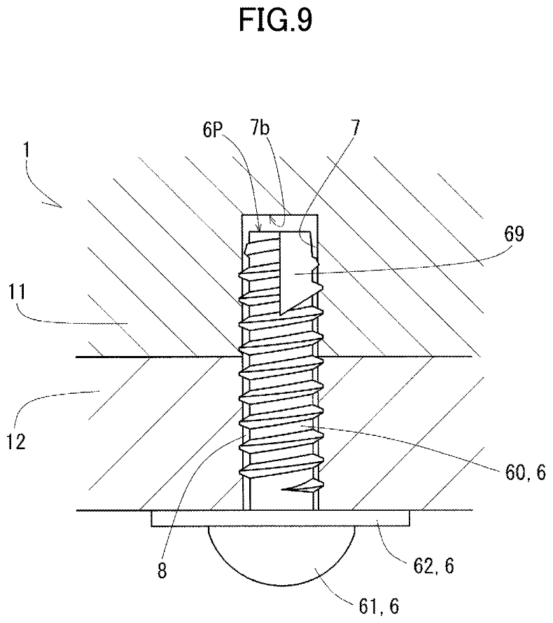

The self-tapping screw 6 used in the first through third embodiments may be a self-tapping screw 6 of the B-1 type shown in FIG. 9. The B-1-type self-tapping screw 6 has a groove 69 at the tip thereof. The edge of the groove 69 of the B-1-type self-tapping screw 6 serves as a cutting blade.

### <Test Example>

In test examples, core samples No. 1 through No. 5 were made as described in the following. A check was then made as to whether a crack was developed during the making of cores. Further, the core loss of the rotating electrical machine using the cores No. 1 through No. 5 was evaluated.

### <<Data of Samples>>

Sample No. 1

Core sample No. 1 is a core made by fixing separately produced teeth and a yoke together with an adhesive. The relative density of both the teeth and the yoke was 95%.

Sample No. 2

Core sample No. 2 is a core made by fixing teeth and a yoke together with self-tapping screws. The self-tapping screws were ENPLATIGHT (product name) by NITTOSEIKO CO., LTD. The dimensions and relative densities of the teeth and the yoke are the same as in the first embodiment. The self-tapping screw was of the B-0 type. with the major diameter being 3 mm, and the minor diameter being 2.3 mm. Further, the inner diameter of the pilot hole was 2.4 mm. The inner diameter of the pilot hole 7 is the diameter before the self-tapping screw is attached. The inner diameter of the pilot hole/the major diameter of the self-tapping screw is 0.8. Namely, the inner diameter of the pilot hole was 80% of the major diameter of the self-tapping screw. The self-tapping screws were attached by an electric screwdriver. The rotation rate of the self-tapping screws was 300 rpm, and the force to rotate the self-tapping screws was 49 N·m.

Sample No. 3

Core sample No. 3 is the same as core sample No. 2, except that the inner diameter of the pilot hole is 2.5 mm. The inner diameter of the pilot hole of sample No. 3 was 83% of the major diameter of the self-tapping screw.

Sample No. 4

Core sample No. 4 is the same as core sample No. 2, except that the inner diameter of the pilot hole is 2.8 mm. The inner diameter of the pilot hole of sample No. 4 was 93% of the major diameter of the self-tapping screw 6.

Sample No. 5

Core sample No. 5 is the same as core sample No. 2, except that the inner diameter of the pilot hole is 2.9 mm. The inner diameter of the pilot hole of sample No. 5 was 97% of the major diameter of the self-tapping screw 6.

Sample No. 6

Core sample No. 6 is the same as core sample No. 2, except that the major diameter of the self-tapping screw 6 is 4 mm, that the minor diameter is 3.0 mm, and that the inner diameter of the pilot hole is 3.6 mm. The inner diameter of the pilot hole of sample No. 5 was 90% of the major diameter of the self-tapping screw.

### <<Test Result>>

Checks were then made to see whether there was a crack, and to evaluate core loss (W/kg). Whether there was a crack was determined by visual inspection. The conditions for measuring core loss were 1.0 T/1 kHz. The results of each sample were shown in Table 1. In Table 1, “the inner diameter of the pilot hole/the major diameter of the self-tapping screw” is shown as “PILOT HOLE DIAMETER/MAJOR DIAMETER”. “PRESENCE/ABSENCE OF CRACK” in Table 1 shows whether a hairline-shape crack was developed in either the yoke or the teeth.

For each sample, starting torque (N·m), breaking torque (N·m), a proper tightening torque range (N·m), a loosening torque ratio (%), and a pull-out force (kN) were measured. The starting torque is the torque at which a thread starts to be formed in the pilot hole. The breaking torque is the torque at which at least one of the male thread of the self-tapping screw and the female thread formed in the pilot hole breaks. The starting torque and the breaking torque were measured by using a commercially available torque measurement device. The greater the size of the self-tapping screw is, the greater the starting torque and the breaking torque are.

The proper tightening torque range is a range of torque from 1.5× starting torque to 0.65× breaking torque. The wider the range is, the easier the tightening of the self-tapping screw is, and the easier it is to fasten the self-tapping screw to an object.

The loosening torque ratio is represented as (T/1)×100 when torque T is required to loosen the self-tapping screw by reverse rotation after tightening the self-tapping screw by a force of 1 N·m. It can be determined that the self-tapping screw has bitten into a pilot hole when a loosening torque ratio is greater than or equal to 50%.

The pull-out strength was measured by using a measurement-purpose sample that was prepared separately from a core. The measurement-purpose sample is a compressed powder mass made of the same material and having the same relative density as the core. The measurement-purpose sample has a through hole formed therethrough as a pilot hole. The pull-out force is the maximum load needed to push out a self-tapping screw from the pilot hole by pressing the tip of the shank of the self-tapping screw, i.e., the end thereof opposite from the head, after the self-tapping screw is tightened in the pilot hole of the measurement-purpose sample. The greater the pull-out force is, the more unlikely it is for the self-tapping screw to disengage from the pilot hole.

TABLE 1

| Sample No. | 1 | 2 | 3 | 4 | 5 | 6 |
|---|---|---|---|---|---|---|
| Screw Major | — | 3 | 3 | 3 | 3 | 4 |
| Diameter (mm) | | | | | | |
| Screw Minor | | 2.3 | 2.3 | 2.3 | 2.3 | 3.0 |
| Diameter (mm) | | | | | | |
| Pilot Hole | — | 2.4 | 2.5 | 2.8 | 2.9 | 3.6 |
| Diameter (mm) | | | | | | |
| Pilot Hole | — | 0.80 | 0.83 | 0.93 | 0.97 | 0.90 |
| Diameter/Major | | | | | | |
| Diameter | | | | | | |
| Presence/Absence | Absent | Present | Absent | Absent | Absent | Absent |
| of Crack | | | | | | |
| Core Loss (W/Kg) | 95 | 30 | 26 | 26 | 26 | 26 |
| Starting Torque | — | — | 0.49 | 0.42 | 0.15 | 0.603 |
| (N · m) | | | | | | |
| Breaking Torque | — | — | 3.01 | 2.54 | 1.44 | 3.541 |
| (N · m) | | | | | | |
| Proper Tightening | — | — | 1.10 | 0.75 | 0.41 | 1.40 |
| Torque | | | | | | |
| Range (N · m) | | | | | | |
| Loosening | — | — | 57 | 64 | 72 | 62 |
| Torque Ratio (%) | | | | | | |
| Pull-Out | — | — | 1.20 | 1.11 | 0.89 | 1.09 |
| Force [kN] | | | | | | |

As shown in Table 1, the core loss of sample No. 1 was 25 W/kg. Further, sample No. 1 in which the teeth and the yoke are interconnected with an adhesive is inevitably free of a crack.

A crack occurred in the teeth and the yoke in the case of core sample No. 2 in which the inner diameter of the pilot hole was less than 83% of the major diameter of the self-tapping screw. In contrast, no crack occurred in either the teeth or the yoke in the case of core samples No. 3 through No. 6 in which the inner diameter of the pilot hole was greater than or equal to 83% of the major diameter of the self-tapping screw. Accordingly, it was found that the inner diameter of a pilot hole needs to be greater than or equal to 83% of the major diameter of a self-tapping screw to ensure that a yoke and teeth formed from compressed powder masses be fixed together with self-tapping screws.

The core loss of sample No. 2 was greater than the core loss of sample No. 3 and the core loss of sample No. 6. It is estimated that the core loss of sample No. 2 was large because of the occurrence of a crack in the core.

With respect to core sample No. 5 in which the inner diameter of the pilot hole exceeds 95% of the major diameter of the self-tapping screw, the proper tightening torque range of the self-tapping screw was narrow, and it was difficult to tighten the self-tapping screws. With respect to core sample No. 5, the pull-out force was weak, and it was easy for the self-tapping screws to disengage from the pilot holes. In contrast, with respect to core samples Nos. 3, 4, and 6 in which the inner diameter of the pilot hole was less than or equal to 95% of the major diameter of the self-tapping screw, the proper tightening torque range of the self-tapping screw was wide, and it was easy to tighten the self-tapping screws. Further, with respect to core samples Nos. 3, 4, and 6, the pull-out force was strong, and it was difficult for the self-tapping screws to disengage from the pilot holes.

### DESCRIPTION OF REFERENCE SIGNS

100 rotating electrical machine
1 interconnected assembly
11 first member, 12 second member
2 rotor
20 shaft, 21 support plate, 22 magnet
3 stator
30 core, 31 coil, 33 bearing
4 teeth
5 yoke
6 self-tapping screw
60 shank, 61 head, 62 washer, 65 thread, 65t crest
66 valley, 69 groove
7 pilot hole
8 gap
8r filler material
80 predetermined area
L1 first straight line, L2 second straight line, L3 third straight line, L4 fourth straight line
9 housing

1. An interconnected assembly comprising:
a first member formed from a compressed mass of soft magnetic powder;
a second member that is a separate piece from the first member; and
a self-tapping screw extending through the second member to reach the first member to interconnect the first member and the second member,
wherein at least the first member, among the first member and the second member, has a pilot hole into which a thread of the self-tapping screw bites,
wherein an inner diameter of the pilot hole is greater than or equal to 83% and less than or equal to 95% of a major diameter of the self-tapping screw, and is greater than a minor diameter of the self-tapping screw, and
wherein a helical gap is formed between an outer circumferential surface of the self-tapping screw and an inner circumferential surface of the pilot hole.

2. The interconnected assembly as claimed in claim 1, wherein the second member is formed from a compressed mass of soft magnetic powder, and
the pilot hole extends from the first member through the second member.

3. The interconnected assembly as claimed in claim 1, wherein a proportion of an area of the gap in a total of a predetermined area in a cross-section taken along a plane including an axis of the self-tapping screw is greater than or equal to 45% and less than or equal to 65%,
the predetermined area being defined by
a first straight line connecting one crest of the thread and another crest of the thread adjacent thereto in a direction of the axis,
a second straight line including a root of the self-tapping screw and extending along the root,
a third straight line extending from the one crest of the thread in a direction perpendicular to the axis, and
a fourth straight line extending from the another crest of the thread in the direction perpendicular to the axis.

4. The interconnected assembly as claimed in claim 1, wherein the self-tapping screw is of a B-0 type or a B-1 type.

5. The interconnected assembly as claimed in claim 1, wherein a thread angle at a distal section of the self-tapping screw is smaller than a thread angle of a proximal section thereof.

6. The interconnected assembly as claimed in claim 1, wherein the self-tapping screw is a nonmagnetic material.

7. The interconnected assembly as claimed in claim 6, wherein the nonmagnetic material is resin, a titanium alloy, brass, an aluminum alloy, a magnesium alloy, or nonmagnetic stainless steel.

8. The interconnected assembly as claimed in claim 1, wherein the self-tapping screw is a magnetic material.

9. The interconnected assembly as claimed in claim 8, wherein the magnetic material is steel or magnetic stainless steel.

10. The interconnected assembly as claimed in claim 1, wherein five or more ridges of the thread bite into the pilot hole of the first member.

11. The interconnected assembly as claimed in claim 1, wherein a distance between a bottom of the pilot hole and a tip of the self-tapping screw is greater than or equal to 0.5 mm and less than or equal to 5 mm.

12. The interconnected assembly as claimed in claim 1, wherein the inner circumferential surface of the pilot hole has a tapered shape with an angle of 1 degree or more and 10 degrees or less relative to an axis of the pilot hole.

13. The interconnected assembly as claimed in claim 1, wherein in a cross-section taken along a plane including an axis of the self-tapping screw, a thickness of the first member and a thickness of the second member extending from the inner circumferential surface of the pilot hole in a direction perpendicular to the axis are greater than or equal to 2 mm.

14. The interconnected assembly as claimed in claim 1, wherein a filler material is disposed in the helical gap.

15. The interconnected assembly as claimed in claim 1, wherein a head of the self-tapping screw is a countersunk head, a truss head, or a binding head.

16. The interconnected assembly as claimed in claim 1, wherein a relative density of the first member is greater than or equal to 90%, and
wherein the second member is a compressed mass of soft-magnetic powder, and a relative density of the second member is greater than or equal to 90%.

17. The interconnected assembly as claimed in claim 1, wherein the first member is a tooth used for a core of a rotating electrical machine, and
the second member is a yoke used for the core.

18. The interconnected assembly as claimed in claim 1, wherein the first member is a tooth used for a core of a rotating electrical machine, and
the second member is a flange section provided at an end of the tooth.

19. The interconnected assembly as claimed in claim 1, wherein the first member is a core used in a rotating electrical machine and including teeth and a yoke, and
the second member is a housing for containing the core.

20. An axial-gap-type rotating electrical machine in which a rotor and a stator are arrayed in a direction of a rotation axis of the rotor, comprising
the interconnected assembly of claim 17.
